(19) United States
(12) Patent Application Publication
(10) Pub. No.: US 2023/0281493 A1
(43) Pub. Date: Sep. 7, 2023

(54) Forecasting method for flood crest magnitude and arrival time

(71) Applicant: University of Iowa Research Foundation, Iowa City, IA (US)

(72) Inventor: Marian Muste, Iowa City, IA (US)

(73) Assignee: University of Iowa Research Foundation, Iowa City, IA (US)

(21) Appl. No.: 18/175,371

(22) Filed: Feb. 27, 2023

Related U.S. Application Data
(60) Provisional application No. 63/315,879, filed on Mar. 2, 2022.

(51) Int. Cl. G06N 5/046

(52) U.S. Cl. CPC G06N 5/046

(57) ABSTRACT

A data-driven method for streamflow forecasting is provided. The method includes steps of measuring index velocity at an index velocity gaging station associated with a stream to provide index velocity data, simultaneously with measuring the index velocity, measuring water stage at the index velocity gaging station to provide stage data, and applying a data-driven model implemented using a computing device to the index velocity data and the stage data, the data-driven model further using historical index velocity data and historical stage data collected at the station to forecast at least one of magnitude and timing of a flood crest arrival during occurrence of a hydrological event. The index-velocity data and the stage data may be concurrently collected using a Horizontal Acoustic Doppler Current Profiler (HADCP). The method may further include generating using the computing device an alert in advance of flood crest.

### RELATED APPLICATIONS

This application claims priority to U.S. Provisional Patent Application No. 63/315,879, filed Mar. 2, 2022, which is hereby incorporated by reference in its entirety.

### FIELD OF THE INVENTION

The disclosure relates to forecasting methods for flooding. More particularly, but not exclusively, the disclosure relates to a data-driven forecasting method for flood crest magnitude and arrival time.

### BACKGROUND

The expectation of improved flood warnings has become critical for many agencies and communities at a time when flooding is increasingly severe and widespread [1]. Key questions for flood crisis managers are still not adequately answered: a) How high will the river rise? b) When will the river reach its peak? c) How long will flooding last? Addressing these key questions requires understanding the science driving floods over various spatio-temporal scales [2], [3], [4], using adequate predictive models [5], and supplying accurate input datasets for the modeling execution[6]. In addition to the quantitative precipitation forecasts from numerical weather prediction models, the current streamflow forecasting is typically provided by coupled hydrological-hydraulic models with input and boundary conditions provided by direct measurements of water cycle variables. The reliability of flood warnings depends on the models' skills, the assumptions used for the modeling scenarios, and the quality of the input data used for the modeling. In general, flood warnings are still under the desired level of accuracy as they accumulate uncertainties generated by precipitation prediction, the runoff modeling itself, routing methods, and setting boundary conditions for in-stream flow simulations [7], [8],[9].

Therefore, what are needed are new method and systems which address these problems and deficiencies with the current state of the art.

### SUMMARY

Therefore, it is a primary object, feature, or advantage to improve over the state of the art.

It is a further object, feature, or advantage to provide methods and systems for accurate forecasting of flood crests and issue appropriate hazard warnings.

It is a still further object, feature, or advantage to provide methods and systems for accurate forecasting of flood crests using only in situ measured in-stream data. Yet another object, feature, or advantage is to provide a forecasting method for flood crest magnitude and arrival time that captures the dynamics of unsteady flows.

Another object, feature, or advantage is to provide data-driven forecasting that does not require conventional physical-based modeling (i.e., numerical simulations for forecasting precipitation and runoff entering the stream at the forecast location).

Yet another object, feature, or advantage is to forecast flood hazards using directly measured index-velocity and stage alone.

One or more of these and/or other objects, features, or advantages will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

Streamflow forecasting generally relies on coupled rainfall-runoff-routing models calibrated and executed with data estimated by monitoring protocols that do not fully capture the dynamics of unsteady flows. This limits the ability to accurately forecast flood crests and issue hazard warnings. Here we use directly measured datasets acquired for streamflow estimation to develop a data-driven forecasting algorithm that does not require conventional physically-based modelling. We test the potential of our algorithm using measurements acquired at an index-velocity gaging station on the Illinois River, USA, between 2014 and 2019. We find that the forecasting protocol is able to deliver short term predictions of flood crest magnitude and arrival time. The algorithm produces better agreement with larger events and is more reliable for single-peak storms possibly due to the prominence of hysteretic behavior in such events. We conclude that flood hazard can be forecast using directly measured index-velocity and stage alone.

According to one aspect, a data-driven method for flood crest forecasting is provided. The method includes steps of simultaneously measuring the index velocity and measuring water stage at the index velocity gaging station to provide streamflow (i.e., discharge) data, and applying a data-driven model implemented using a computing device to the index velocity data and the stage data, the data-driven model further using historical index velocity data and historical stage data collected at the station to forecast at least one of magnitude and timing of a flood crest arrival during occurrence of a hydrological event. The index-velocity data and the stage data may be concurrently collected using a Horizontal Acoustic Doppler Current Profiler (HADCP). The method may further include generating using the computing device an alert in advance of flood crest based on at least one of the magnitudes and the time of the flood crest arrival.

According to another aspect, a system for implementing a data-driven method for streamflow forecasting is provided. The system includes a memory, a processor operatively connected to the memory, and a set of instructions stored on the memory for execution by the processor wherein the set of instructions are configured to apply a data-driven model to index velocity data and stage data, the data-driven model further using historical index velocity data and historical stage data to forecast at least one of magnitude and timing of a flood crest arrival during occurrence of a hydrological event. The system may further include an index velocity measuring device for measuring the index velocity data and a water stage measuring device for measuring stage data concurrently with the measuring of the index velocity data.

According to another aspect, a data-driven method for flood crest characteristics (i.e., time of arrival and stage magnitude) forecasting is provided. The method includes measuring index velocity at an index velocity gaging station to provide index velocity data, simultaneously with measuring the index velocity, measuring water stage at the index velocity gaging station to provide stage data, and applying a data-driven model implemented using a computing device to the index velocity data and the stage data, the data-driven model further using historical index velocity data and historical stage data collected at the station to forecast at least one of magnitude and timing of a flood crest arrival during occurrence of a hydrological event.

### BRIEF DESCRIPTION OF THE DRAWINGS

Illustrated embodiments of the disclosure are described in detail below with reference to the attached drawing figures, which are incorporated by reference herein.

FIGS. 1A-1J are hysteresis effects on flow variables. FIG. 1A shows stage vs. free-surface water slope[4]. FIG. 1B shows stage vs. index velocity[19]. FIG. 1C shows stage vs. discharge[4].

FIG. 1D shows Hydrograph phase sequencing[4]. FIGS. 1E, 1F, and 1G show relationships for pairs of variables measured during a flood wave propagating through USGS #05558300 index-velocity station. FIG. 1H, FIG. 1I, and FIG. 1J show relationships for pairs of variables measured with the CSA method during a flood wave propagating at USGS #05454220 [18]. Rising and falling terms in the plots specify stage variation phases (i.e., from steady flow to Hₘₐₓ).

FIGS. 2A, 2B are identification of the hysteresis-related patterns for developing flood wave crest amplitude and arrival time forecasting protocol. FIG. 2A illustrates a single-pulse storm event. FIG. 2B illustrates a multiple-pulse storm event.

FIGS. 3A, 3B are parameterized velocity-stage peak correlations. FIG. 3A illustrates index-velocity vs. stage peak lag; FIG. 3B illustrates index-velocity gradient vs. associated stage peak. Note: the unsteadiness coefficient, a*, is determined with Equation (4) for 2014-2018 training dataset (see Methods section).

FIG. 4A-4C are construction and usage of the flood wave crest amplitude and arrival time forecasting protocol. FIG. 4A illustrates unsteadiness coefficients for the pulses in the training dataset grouped by warning severity levels. FIG. 4B illustrates regression lines for the index velocity peak and the corresponding lag times in the stage progression response grouped by warning severity levels. FIG. 4C illustrates regression lines for the gradients of index-velocities and stages to their peaks grouped by warning level severity. Note: the straight lines display forecasted values based on the status of the parameters at the start of storm pulse #50 (see Forecasting protocol implementation in Methods section).

FIG. 5 illustrates one example of a system for forecasting.

FIG. 6 illustrates one example of a method for forecasting.

### DETAILED DESCRIPTION

The discussions in this disclosure revolve around one of the components of predictive modeling: the unsteady channel flow routing. Channel routing impacts the timing and magnitude of the flood elevations at specific locations [5], [10]. In turn, flood elevations along the channel length determine the capacity of the river to contain the flood discharge (which may vary in space and time) as well as the flood extent over the floodplains [11]. Channel routing models are calibrated, validated, and run with long-term streamflow data that most often are based on streamflow monitoring relationships (a.k.a ratings) that overlook some aspects of the stream dynamics during unsteady flow propagation. Knight [12] points out that these relationships are not suitable for modern hydraulic analysis. Moreover, these ratings display uncertainties for the higher flow range because the calibration points are less dense in this flow range [13]. In addition, the use of assumed rather than observed boundary conditions in modeling unsteady flows can produce uncertainties that can exceed those generated by modeling itself [14].

Most often, the streamflow monitoring relationships supporting forecast modeling rely on stage-discharge and index-velocity ratings derived empirically [15], [16]. Their construction is based on statistical analysis uniformly applied to extensive datasets collected in steady and unsteady flows. These one-to-one ratings are subsequently used for estimating steady and unsteady flows, even though, in the latter case, the relationships between flow variables are different for the rising and falling phases of the flow hydrographs [4]. This non-single-valued dependence of the relationships is labeled by the hydrometric community as hysteresis to indicate that the status of the flow at any given time is dependent on its history in reaching that state. With the advent of affordable and fast sampling rate pressure transducers, the Continuous Slope-Area (CSA) method has also been tested for continuous streamflow monitoring [17], [18]. This method was originally developed for extending the stage-discharge rating in areas of high flows using high water marks left on the ground after flood recess.

Hysteresis is inherent during the gradual propagation of flood waves, regardless of the river size [4]. Flood wave signature can affect up to 50% of the annual streamflow cycle in many unregulated rivers [19] and in even higher percentages in regulated rivers [20]. Note that in some situations the hysteresis effect on the monitoring methods is small. This is certainly the case for fast flows propagating on larger streambed slopes. However, for intermediate and lowland streams exposed to fast-varying flows, the hysteretic behavior is prominent. In medium-sized streams exposed to rapidly changing and unsteady flows, differences of up to 30% have been found between streamflows estimated with stage-discharge ratings and the actual flows [20]. Currently, the United States Geological Survey (USGS) delivers real-time discharge data for approx. 9,000 sites across the nation, most of them relying upon stage measurements and a stage-discharge rating to estimate discharge in real-time. A recent evaluation by the USGS of 5,420 of its gaging stations that use stage-discharge ratings found 67% of the stations are potentially moderately or strongly affected by hysteresis [21]. Despite its ubiquitous presence and considerable impact on data accuracy acquired with conventional monitoring methods, there is no indication of systematic efforts to identify the sites prone to hysteresis and account for hysteresis effects in real time.

Hysteresis is well documented in the canonical literature [22], [23] and known to monitoring agencies [21], [24]. Actually, the stage-discharge rating misses the hysteretic behavior altogether because this rating is the same for the rising and falling limbs of the hydrograph. Corrections or more complex semi-empirical ratings can be applied to recover the hysteretic loop associated with the flood wave. However, complex rating is only applied to rivers located in major flood-prone areas, with the purpose of providing more accurate data for streamflow forecasting models. Hysteresis occurring in medium and small inland rivers is undocumented in most cases, as the hydrometry community perceives that the hysteresis impact is small and cannot be discerned from instrument uncertainty [21].

The index-velocity monitoring method is better at capturing the unsteady flow dynamics as it adds the index velocity (a kinematic flow parameter) to stage measurement (geometric flow parameter). Consequently, the index-velocity method displays loops in the relationships among the variables (quasi-circular shapes when represented graphically). However, the construction of the index-velocity ratings is based on statistical analyses leading to one-to-one relationships like those for the stage-discharge ratings, hence its accuracy is still under scrutiny [IX]. While the CSA method captures hysteresis and does not need ratings, it is still rarely used (if at all) for continuous flow monitoring at operational gaging stations. Currently, none of the continuous monitoring methods are used to forecast streamflow based only on the measured data.

The focal point of this disclosure is to reveal the hysteretic behavior of flow variables as documented by in situ measurements acquired with the index-velocity (mostly) and CSA methods (for completeness), and to illustrate that, by exploiting subtle features of hysteresis behavior, we can develop protocols for forecasting the flood crest properties by relying only on measured data, without having to make recourse to physically-based numerical modeling. Our discussions are relevant for conditions where hysteresis is produced by unsteady flow acting in isolation from other potential causes (e.g., effects of instream vegetation, development of bedform-induced roughness, and baseflow-stream interactions). Furthermore, we only consider flows predominantly controlled by friction (channel control) rather than bedform features (local control). For the present context, we will limit the discussed hysteresis-related impacts to in-bank flows as above the bankfull stage, the mass and momentum exchanges between the main channel and floodplain generate additional flow complexities. Under these conditions, the unsteady flow in natural channels can be described by canonical open-channel equations [22], [25]. The forecasting method can be extended to include the floodplain if additional variables are included in the forecasting data-driven model. However, once the bankfull stage is exceeded, the flooding occurs, therefore the proposed method suffices to alert community about the flood hazard potential.

This disclosure starts by re-reviewing the governing equations for unsteady open-channel flows to substantiate the hysteresis origin and its impact on the flow variables measured in situ. The methods portion of this disclosure describes the basis of a new forecasting algorithm and illustrates, using the index-velocity acquired at an existing gaging station, how this algorithm can anticipate the flood crest characteristics. Finally, we highlight the contributions brought by the proposed method and means to further optimize some of its aspects.

### Results and Discussion

### Relevant Features of Unsteady Open-Channel Flow Dynamics

It is well known that flow variables are non-uniquely related during the ascending and descending phases of gradual time-varying flows⁴. While this statement is rarely proven with data acquired in field conditions, there are several laboratory studies that demonstrate this fundamental aspect of unsteady flow dynamics^{26,27}. Laboratory studies also found that the differences between flow phases are more prominent for high flows and rate changes [28],[29]. For substantiating the origins of these differences, we reference to the Saint-Venant equations that are often used in hydraulic modeling to describe unsteady flow propagation in streams [22]. A convenient form of these equations for the present context is the one offered by Knight¹² where the unsteady flow discharge, Q, is related to that in steady and uniform flow, Qs:

$$Q = {Q}_{s} \sqrt{1 - \frac{1}{{s}_{0}}} \frac{\partial h}{\partial x} - \frac{U}{{gS}_{0}} \frac{\partial U}{\partial x} - \frac{1}{{gS}_{0}} \frac{\partial U}{\partial t} \qquad ( 1 )$$

$$kinematic wave \to \to \vert$$

$$diffusion wave \to \to \to \to \to \to \to \vert$$

$$full dynamic wave \to \to \to \to \to \to \to \to \to \to \to \to \to \to \to \to \to \to \to \to \to \vert$$

$$with$$

$${Q}_{s} = ( 1 / n ) {AR}^{2 / 3} \sqrt{{S}_{0}} = K \sqrt{{S}_{0}}$$

where Q is the unsteady flow discharge, h is the flow depth, U is the cross-section mean velocity, t is time, and x is the distance along the channel direction. Note: flow depths in natural streams are determined by measurements of free surface elevation (a.k.a. stage), H. The steady-uniform flow discharge, Qs, is obtained with Manning's equation (see Equation 2), where n is the Manning's roughness coefficient, A the cross-sectional area, R the hydraulic radius, S₀ the bed slope, and K the channel conveyance (in metric units) [22]. Previous use of Equation (1) for channel flow routing has shown that it is satisfactory for all flood wave propagation, regardless of the wave type: kinematic, diffusion, or full dynamic [30], [31], [32]. Equations (1) and (2) are strictly valid up to the bankfull stage of a regularly shaped, prismatic, and straight channel (i.e., without changes of the streambed geometry in the vertical or horizontal planes along the measurement reach) with quasi-constant channel boundary roughness. Fortunately, most of the above requirements are also recommended for selecting the optimum location for the gaging stations [15].

The type of dominant wave for a given situation is determined by the relative contribution of the terms in Equation (1). These terms continuously change their magnitude and signs (i.e., positive or negative) during the flood wave propagation, commensurate with the slope of the streambed at the site, the intensity of the propagating wave (i.e., its magnitude vs. duration), and the flood wave propagation phase [22], [30]. Given that hysteretic effects are more pronounced for non-kinematic waves, there is a need to anticipate the type of wave developing for specific sites and events. The ability to identify the type of wave that will develop at a specific site and flow situation is critical for selecting the appropriate monitoring method and for selecting the appropriate channel flow routing model. With this intention in mind, Lee [33] assembled a set of hysteresis diagnostic formulas that identify thresholds and ranges for the flow variables that are indicative of specific flood wave types developing at a given site. For illustration purposes, Table provides three out of a dozen methods identified by Lee [33]. The diagnostic formulas can be tested for both new and existing monitoring sites by analyzing the sites' hydro-morphological characteristics and streamflow records [191].

TABLE 1
Hysteresis diagnostic formulas [4]

| Reference | Criterion description |
|---|---|
| Fread [34] | Insignificant: Sₒ > 0.001 & 0 < dh/dt < |
| | 1.219 mh⁻¹; moderately |
| | significant: 0.0001 < Sₒ < 0.001 & 0.03 < |
| | dh/dt < 0.914 mh⁻¹; |
| | significant: Sₒ < 0.0001 & dh/dt > |
| | 0.015 mhr⁻¹ |
| Ponce[35] | τ = TSOV/D with τ—parameter, T—wave |
| Crago & | period; V—reference mean flow velocity; |
| Richards[36] | D—reference flow depth, for kinematic |
| | wave: τ > 171, for non-kinematic wave: τ < 171 |
| Dottori[24] | Sₒ ≥ 5 × 10⁻⁴ (steep slope); Good estimator for |
| | kinematic or quasi-kinematic conditions. |

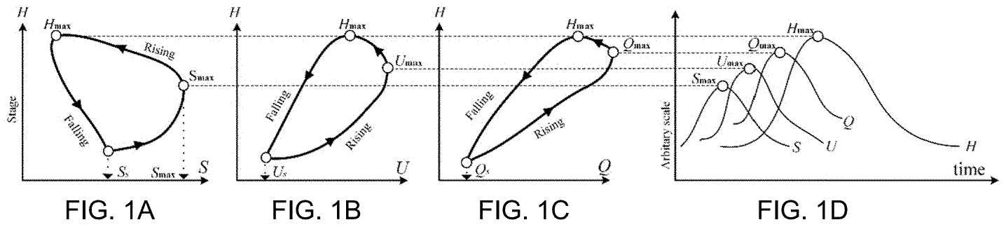

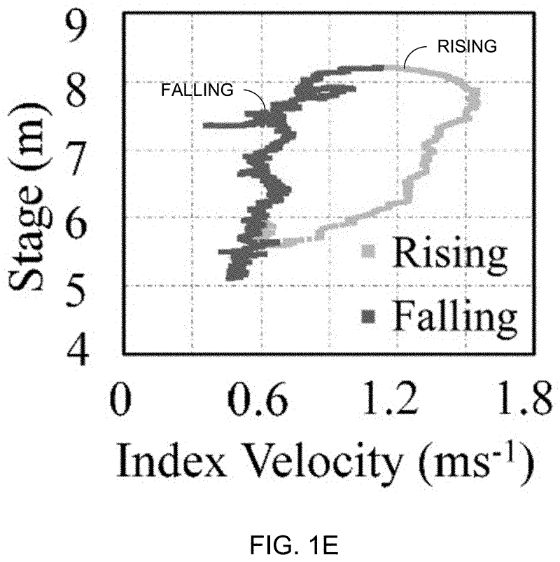

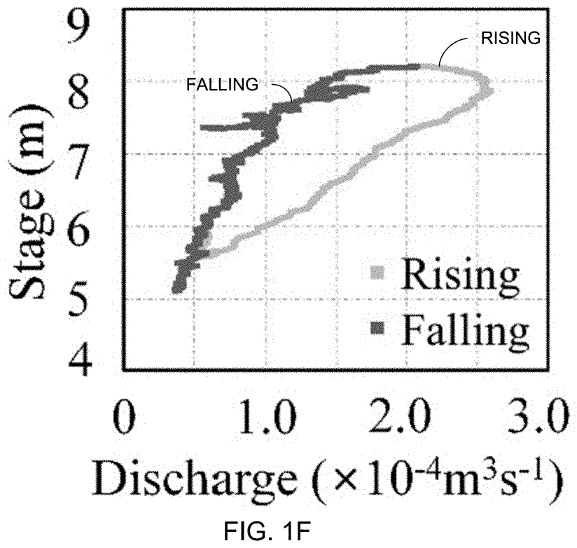

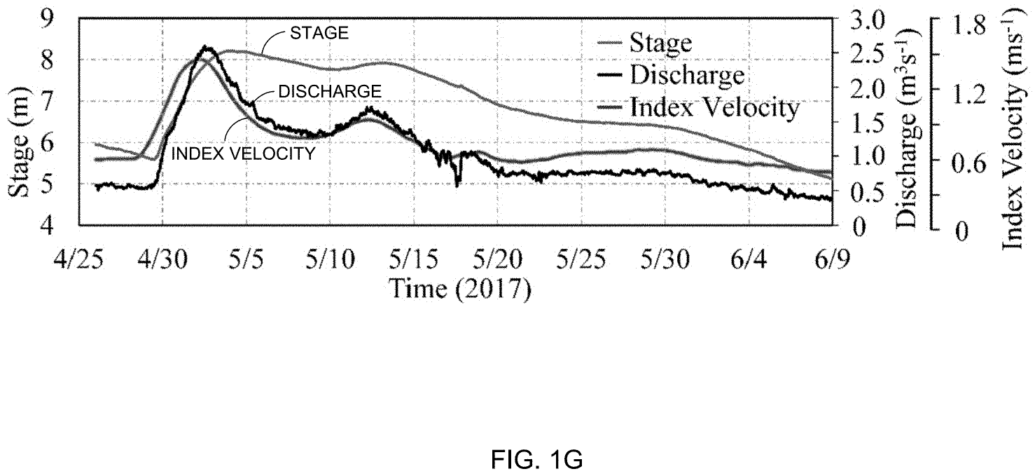

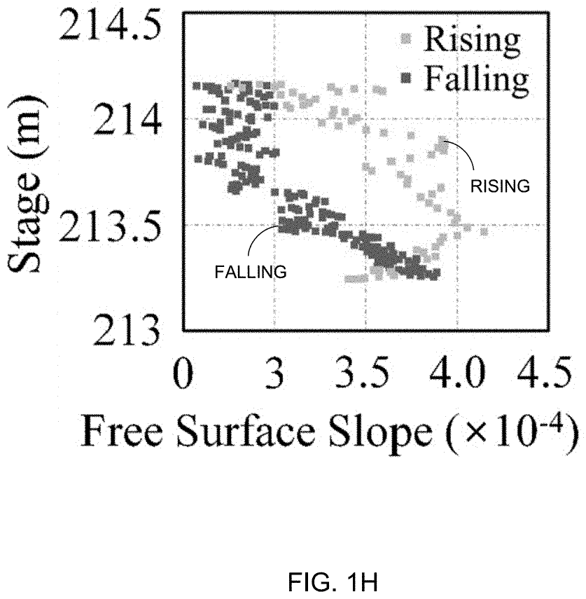

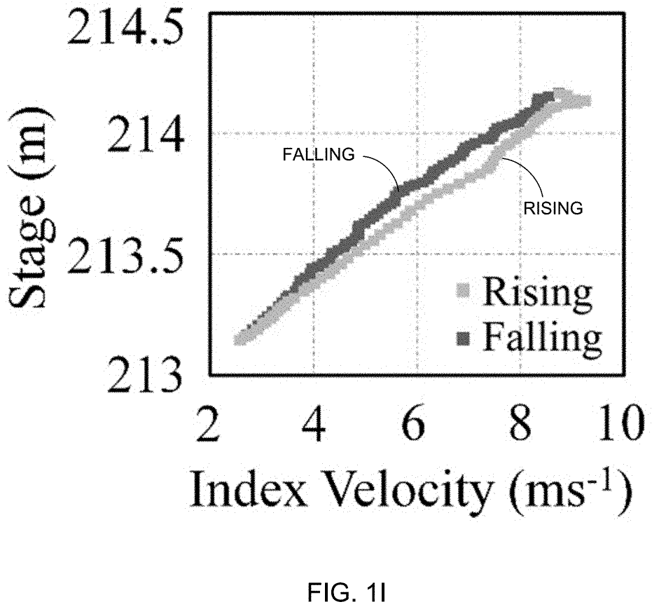

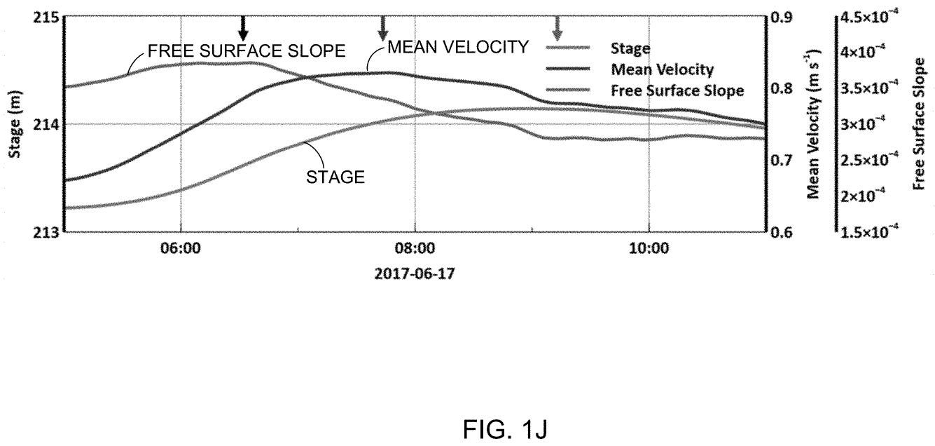

Two main features ensue from Equation (1). First, the relationship between any pair of mean flow variables is distinct on the rising and falling limbs of a flood wave, as illustrated by the loops in FIGS. 1A, 1B, and 1C. Second, the hydrographs of variables used for estimating the discharge are distinct, with their maximum values (a.k.a. peaks) occurring in the following order: energy slope, bulk flow velocity, discharge, and flow depth, as illustrated in FIG. 1D. The discussion of the phasing of the mean flow variables in unsteady flows has been brought only in a handful of previous analytical [37], [38] and experimental [26], [28], [39] studies. Note that if a monitoring method captures hysteresis of flow variables, it also reveals the hydrograph sequencing, and vice-versa [4].

Until recently, hysteretic behavior has rarely been captured in natural streams because of the historical lack of high-temporal resolution instruments and of simultaneous measurement of at least two flow variables. The introduction of the new generation of acoustic-profilers at gaging stations enabled additional and valuable insights into the dynamics of unsteady open-channel flows. One such site, used as a case study herein, is the USGS gaging station #05558300, located on the medium-sized Illinois River, in Illinois, U.S.A. [40]. Before selecting this site for illustrating hysteresis-related features, we explored six years of data recorded at the station to diagnose the hysteresis presence. The implementation of the Dottori et al. [24], Mishra & Seth [41], and Fread [34] diagnostic formulas to the available dataset have compellingly confirmed the possibility of developing diffusion and full dynamic waves even for storms that are relatively moderate in magnitude.

In order to illustrate the hysteresis behavior with field data, we plot in FIGS. 1E, 1F, and 1G samples of directly measured stage and index-velocity time series at the USGS gaging station #05558300, along with the discharges estimated with the index-velocity ratings, for the largest storm of the water year 2017 (retrieved from [40]) using the same format as in FIGS. 1B, 1C, and 1D. To facilitate the identification of the variables' peaks in the latter figures, we applied a variable-span smoother based on local linear fit [42] to the 5-point average stage and index-velocity dataset collected by a Horizontal Acoustic-Doppler Current Profiler (HADCP). The visual inspection of the plots in FIGS. 1E-1G reveals several notable aspects. First, we observe that the shape of the loops in FIGS. 1B and 1C and in FIGS. 1E and 1F, respectively, are similar. Note that the bulk flow velocities shown in FIG. 1B and the index-velocities shown in FIG. 1E are related through a one-to-one relationship (i.e., the index-velocity rating), hence, they preserve the loop shapes. Second, FIG. 1G confirms the separation of the variable hydrographs hinted at in FIG. 1D, and their identical sequencing order.

To complete the illustration of hysteretic impact on flow variables beyond the illustration in FIGS. 1E-1G, we add herein in-situ measurements acquired with the CSA method that capture flow dependencies not observable at an index-velocity station. These measurements were acquired with commercially available pressure sensors in a small lowland stream [18]. The CSA monitoring entailed fast-sampled stage measurements at two close locations to determine the free-surface slope that was subsequently assimilated in Equation (2). Like Equation (1), the implementation of CSA using Equation (2) is only valid for sites that are controlled by friction forces over the measurement reach (i.e., quasi-constant shape and straight channels). FIGS. 1H, 1I, and 1J show the relationships between free-surface slope (that is proportional to the energy slope for short reaches) vs. stage; stage vs. discharge; and the variable hydrographs phasing estimated with the CSA method for one of the spring storms passing through the USGS site #05454220 during the spring of 2017. These plots reveal relationship shapes similar to those illustrated in FIGS. 1A, 1C, and 1D, respectively. The separation in the stage-discharge relationship in FIG. 1I is much smaller than that shown in FIG. 1F because of the wide difference in river size (i.e., about one order of magnitude difference in stream width) and the much narrower range for the variation of the flow variables. Even for such small hysteretic effects, we observed a difference of 16% in the discharge for the same stage in the area of maximum loop thickness. The time difference between the free-surface and stage peaks for the smaller stream is 2.25 hours (see FIG. 1J), much smaller than the 2.5 days observed in the larger stream (see FIG. 1G).

The plots of the direct measurements illustrated in FIG. 1E to 1J reveal that sampling the flow variables in situ with high-temporal resolution measurements allows to capture the hysteresis associated with the gradual propagation of flood waves, regardless of the river size. Measurements utilizing the CSA method also indicate that, for small streams and small flood wave propagating through the measurement site, the effect of hysteresis might be detected with commercially available instruments. More importantly, the phasing of the hydrographs, which is the basis of the forecasting approach discussed herein, is substantiated when using direct measurements of more than one flow variable as is done for both index-velocity and continuous-slope area methods.

### Results

The triggering point for the proposed forecasting protocol stems from the inspection of the time series for stage and index-velocities recorded over six water years at the hysteresis-prone USGS #05558300 station [19]. The inspection highlighted a persistent trend in the index-velocity and stage time series: index-velocity peaks precede the stage peaks. This trend hinted that the index-velocity peak can be used as a pivotal point in anticipating the stage peak. The practical question then becomes: how high-temporal resolution measurements of index-velocity and stage, in conjunction with knowledge on hysteretic behavior in channel flows (see FIG. 1G), can be used to estimate the flood crest arrival time and its magnitude?

The short-term forecasting foundation was obtained by data-mining the records available at the station for identifying the hysteretic-related patterns affecting the index-velocity and stage time series pairs and by parameterizing each pulse occurring during storm events. We define pulses as groups of consecutive data points on the index-velocity hydrograph pertaining to a flow acceleration-deceleration cycle. A single-pulse storm produces one peak in the stage time series that, in fact, represent the flood crest. Multiple-pulse storms result in a flood crest that cumulates the effect of all pulses that occur during the rising phase of the stage hydrograph. The need for distinguishing between single- and multiple pulse storms stems from the fact that each pulse has a unique and distinct impact on the stage hydrograph depending on its past and future progression. The multiple-pulse storms are more common than the single-pulse one in natural channels.

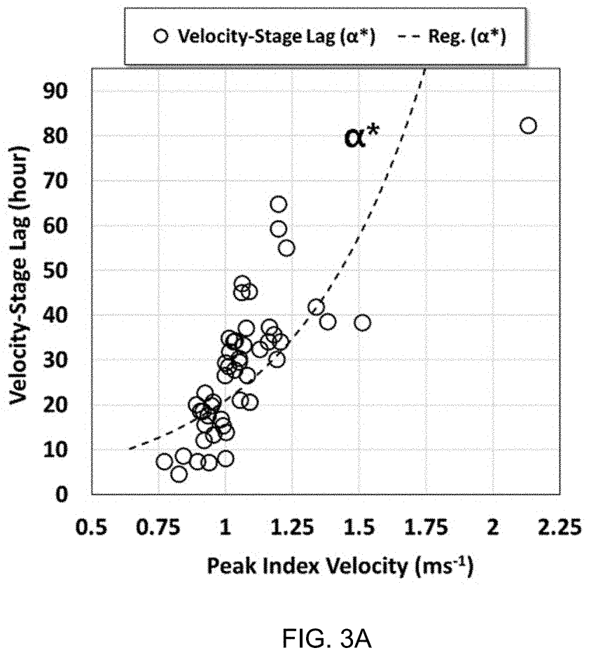

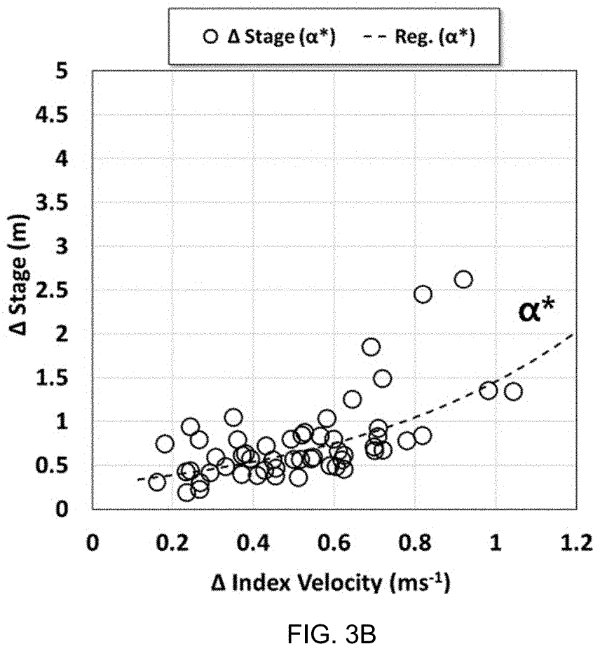

The identified pulses were subsequently parameterized to capture the time-evolving impact of the index-velocity pulses on the associated stage hydrographs accounting for: a) the magnitude of the velocity and stage at the pulse origin; b) the intensity of the pulse (i.e, ratio between pulse peak magnitude and its duration, and the gradient of the acceleration phase); and, c) the phase of the stage hydrograph (rising and falling). The time-resolved parameterization of the velocity-stage peak correlations were assembled in graphical and analytical forms relating: i) the peak index velocity with the associated phase lag of the stage peak; and ii) the magnitude of the index-velocity gradient with the gradient of the associated stage peak. The graphical illustration of the above-mentioned forecasting aids is plotted in FIGS. 3A and 3B. The actual forecasting entails real-time tracking of the incoming index-velocity peaks, backtracking the pulse parameters from their initiation, and entering the corresponding values in the assembled forecasting relationships to anticipate the magnitude and timing of the phase-lagged flood crest. The details of the data-driven forecasting protocol are described in the Methods section.

Below, we test the performance of the developed forecasting protocol using data publicly available at the USGS station #05558300. Table 2 illustrates the performance of the forecasting protocol by comparing the hindcasted values of the flood crest magnitude and time lag between index-velocity and stage peaks with the actual recorded data at the station for the largest storms of the water years 2014-2019. Only three of the storms were above 6.7 m associated with the Action Stage for this location. This stage magnitude is identified by specialized agencies in the U.S. to alert communities for potential flooding in their area [43]. Overall, the differences between the predicted and recorded values of the stage crest are less than 10%, with more than half of the predicted values within a ˜5% range. The differences between the prediction and actual values for the arrival time of the crest are larger than those in predicting the flood crest magnitude. The visual inspection of the forecasting graphs suggests that these differences occur due to the flatter gradients of the forecasting relationship for the flood crest. More investigations are needed to reveal a physically-based explanation for the differences. Another notable feature of the presented results is that the lag between hydrograph peaks for the largest storm of the observation period is between 30 and 65 hours, equivalent to 1.25 to 2.7 days, time interval that enable managers and public to evacuate and make last-minute interventions or to intervene with additional information in the streamflow forecasting modeling executed in real time.

TABLE 2
Forecasting protocol performance tested on the largest annual
storms during 2014-2019

| | Forecast | | | |
|---|---|---|---|---|
| Year- | Stage | Lag | Difference (%) ¹ | |
| Pulse # | (m) | (h) | Stage | Lag |
| 2014 | 5.3 | 33.3 | 5.7 | −3.0 |
| 2015 | 5.9 | 41 | −3.4 | −9.8 |
| 2016 | 6.2 | 27 | 1.6 | −7.4 |
| 2017 | 7.8 | 39 | −5.1 | 2.6 |
| 2018 | 6.9 | 39 | 1.4 | −7.7 |
| 2019 | 9.8 | 64.7 | 3.1 | −0.3 |

¹ the reference values are the measured values of the stages and time of crest arrivals

Inspection of the storms in the available dataset allowed us to observe that larger events produce better agreement between the forecasted and actual magnitude of the forecasting parameters, most probably because of the prominence of the hysteretic behavior in the larger events. Moreover, the analyses seem to indicate that the forecasting are more reliable for single-pulse storms suggesting that more refinements of the algorithm are needed for accurate index-velocity peak predictions in multi-pulse storm events. Unquestionably, many of these inferences will improve with an increase of the number of datapoints in the training datasets and of the number of analysis sites.

### DISCUSSION

Currently, forecasting practices rely on hydrologic/hydraulic modeling developed and run with streamflow data acquired with conventional monitoring methods that most often do not capture the entire complexity of unsteady flow dynamics. The quality of these forecasts improves if the models use data produced by superior instruments embedded in conventional monitoring methods. Relevant examples along this line include the use of real-time delivered data produced at index-velocity stations used for illustration in this disclosure. Use of these superior instruments allows us to re-think monitoring methods altogether by using the directly measured data and their spatial and temporal gradients in conjunction with canonical flow equations, such as Equation (1). Moving away from the traditional, empirically based ratings would unquestionably contribute to reducing uncertainties related to modeling flow routing, thus improving the quality of conventional forecasts. Moreover, the rating-less monitoring methods assure superior quality benchmarks for advancing hydrological understanding of watershed dynamics and better support scientific studies on the changes in water cycles, ecological patterns, and climate trends.

Use of advanced instruments also opens opportunities for developing new forecasting approaches using only streamflow data, rather than having to model all the water cycle components involved in traditional forecasting. The data-driven algorithm presented in this disclosure unequivocally demonstrates such a potential. Exploiting subtle features related to the hysteretic behavior of the flow variables enables us to anticipate the flood crest magnitude and its timing using only in situ measured data. To the best of our knowledge, this forecasting approach has not been published so far. Assimilation of direct measurements in data-driven modeling inferences informed by physically-based channel routing equations has the potential to reduce uncertainties generated by the execution of the conventional multi-component streamflow forecasting with hydraulic/hydrologic models⁴⁴.

The proposed forecasting algorithm has several advantages over conventional approaches. The first advantage entails the formulation of science-sound and cost-effective means of releasing short-term flood warnings using only directly measured data, without relying on hydraulic/hydrologic modeling or rating curves. This demonstrated in the present disclosure with HADCP measurements acquired with well-established infrastructure and operational knowledge at an existing USGS index-velocity gaging station. Notably, the formulation of the early warnings is based solely of continuous measurement of river stage and velocity, without requiring estimation of discharges, a laborious process in itself. This aspect was also hinted by [45] from their observations on the sequencing patterns between stage and free-surface velocity measured with radars during unsteady flows. The proposed algorithm can be readily implemented at any index-velocity stations, especially as this monitoring approach is increasingly used today in areas exposed to hysteresis and backwater effects using a variety of new instruments (e.g., radars and image velocimetry).

The second advantage of the proposed forecasting algorithm is that it can be used for supporting the calibration and validation of predictive channel routing numerical models based on Equation (1) at hysteresis-prone sites with stage-discharge ratings (overwhelming used at existing gaging stations and known to be insensitive to hysteresis). After getting a better understanding of the interplay between velocity and stage relationship during hysteresis (with all its subtleties and particular cases) and development of generic relationships for specific site categories, we can use the forecasting algorithms discussed herein for supporting the calibration and validation of the channel routing models with new type of information. For this purpose, transfer functions relating to the index-velocity and stage should be developed and generalized to be applicable to Equation (1) for future time series scenarios [46]. This development will enable to extend forecasting at any gaging site along the fluvial system and will reduce the uncertainties associated with flood type identification currently involved in running the routing models. Finally, the use of the above-mentioned short-term predictive combination will lower the uncertainty in the streamflow forecasting contributed by the modeling of the precipitation and runoff components.

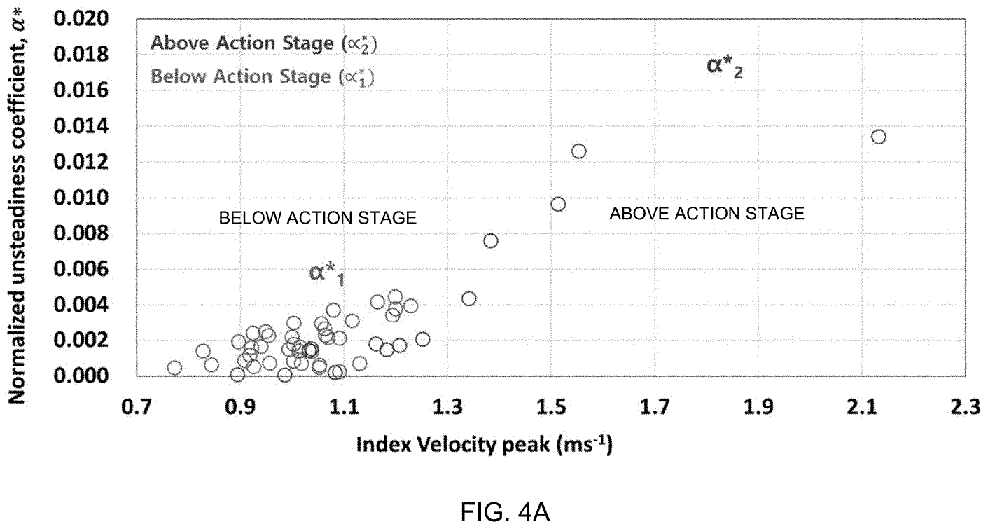

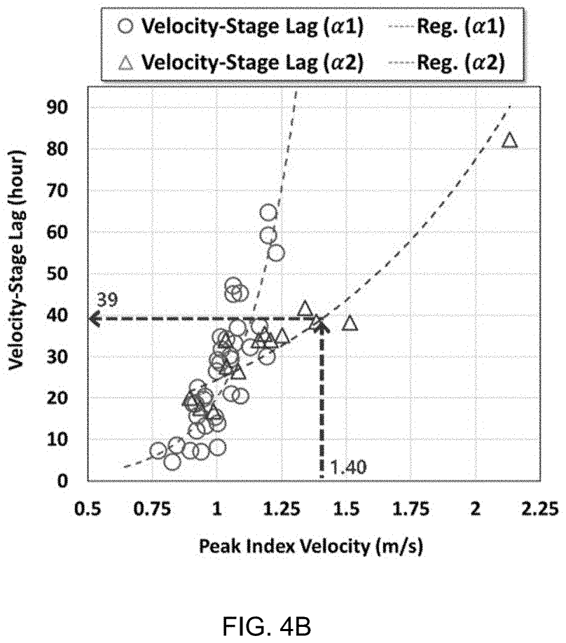

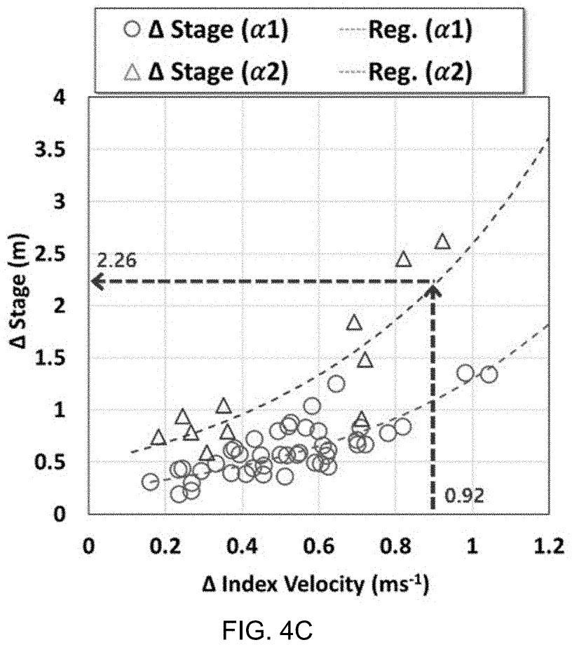

The third advantage is that the skills of the data-driven forecasting algorithms are continuously improving for multiple scenarios with the acquisition of new data at a gaging site. This is in contrast with the modeling-based forecasts that are developed using long-term historical records that need to be re-evaluated for each new simulation [47]. Coupling the data-driven inferences with the flow variables and the associated forecasting parameters (see FIGS. 4B and 4C and Methods section) with the uncertainties in the input parameters within a Bayesian framework [48] could improve the robustness and confidence of the forecasts developed with this approach. At a time when the storms become more intense and frequent, this method will allow to infer the impact of non-stationarity in hydrologic extremes using the observed changes in the flood wave characteristics.

During the proof-of-concept phase of the development of the data-driven forecasting approach, we used only simple analysis tools and manual data manipulations. However, we identified several aspects that can be further optimized for implementation and generalization by using contemporary artificial intelligence tools. Algorithm optimization will require: a) automating the peak variable detection using algorithms for pattern discovery based on dynamic time warping [49]; b) testing of optimum methods for estimating flood wave intensity for single—and multiple—pulse storms; c) testing alternative regression equation types for the forecasting relationships; d) estimating the extent of the time series needed to obtain reliable forecasts; and e) adding simulation modules with real-time data assimilation capabilities for automated prediction of the flood crest arrival and its magnitude. The outcomes of the forecasting implementation described here are valid only for the site where the analysis was conducted, which is obviously insufficient for a robust validation of a data-driven algorithm for the hydrology domain⁵⁰. Generalization of the algorithm requires: a) considerably increasing the number of data-mined time series for a specific site and extending the number of sites to include various hysteresis-sensitive regions; b) extending the proposed data-driven algorithms to build a comprehensive understanding of its performance for various types of hysteresis-prone sites and range of flow conditions.

### CONCLUSION

This disclosure demonstrates that using datasets collected at an index-velocity station with just one instrument unit enables short-term forecasting of the magnitude and timing of a flood crest arrival during the occurrence of hydrological events. We are aware that our proof-of-concept and conclusions are based on a limited dataset. From this perspective, the outcomes of the discussion should be regarded as being indicative rather than confirmative. It is our hope, however, that these discussions illustrate the beneficial aspects of detecting and using hysteresis behavior as a reliable means of producing a new way for streamflow forecasting using only direct in situ measurements. The proposed data-driven approach can be independently used for delivering short-term forecasts for the magnitude and arrival time of a flood crest, free of ratings and without resorting to modeling. The approach can also be complementary used to supplement physically-based modeling within a data assimilation framework to take advantage of the precipitation forecasts.

While still in its infancy, there is convincing evidence that the algorithm presented here can provide important scientific insights into the propagation of flood waves though river networks, and the much-needed impetus to revise and refine the methodologies for more accurately monitoring unsteady flows. The capability to provide observation-based predictions on the sequence and timing of the hydrographs of index-velocity and stage in real time are essential for flood defense agencies to accurately provide flood warnings to the public that can protect life and property, especially in rivers without modeled forecast points. Once fully developed and tested, this method can turn many of the nation's and world's stations exposed to hysteresis into independent, short-term, streamflow forecast points. The implementation of the forecasting approach proposed herein can advance flood science with data-based inferences that enable a systematic investigation of the effect of variable flood wave velocities propagating through a channel network and, hence, the creation of a more accurate spatial flood scaling. This goal can only be achieved by implementing novel techniques for observing, in a systematic and widespread fashion, the physical phenomena relevant to water transport in the landscape.

### Methods

### Forecasting Method Conceptualization

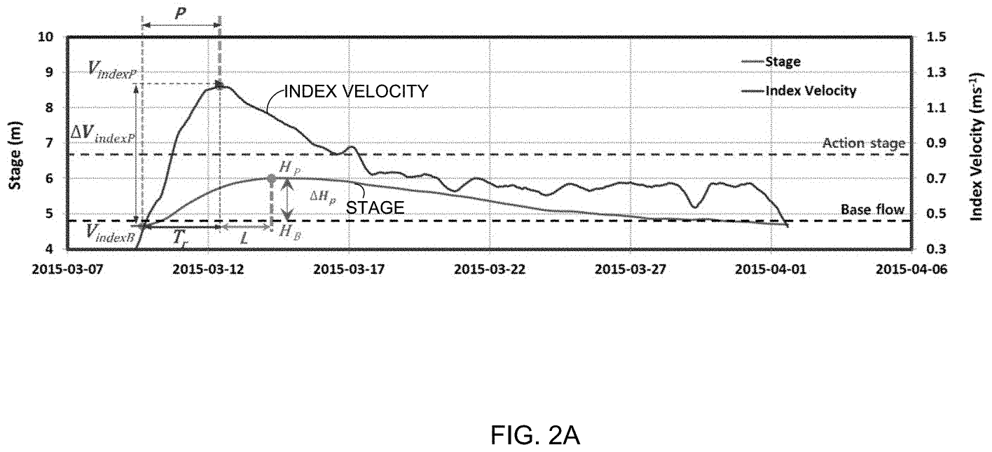

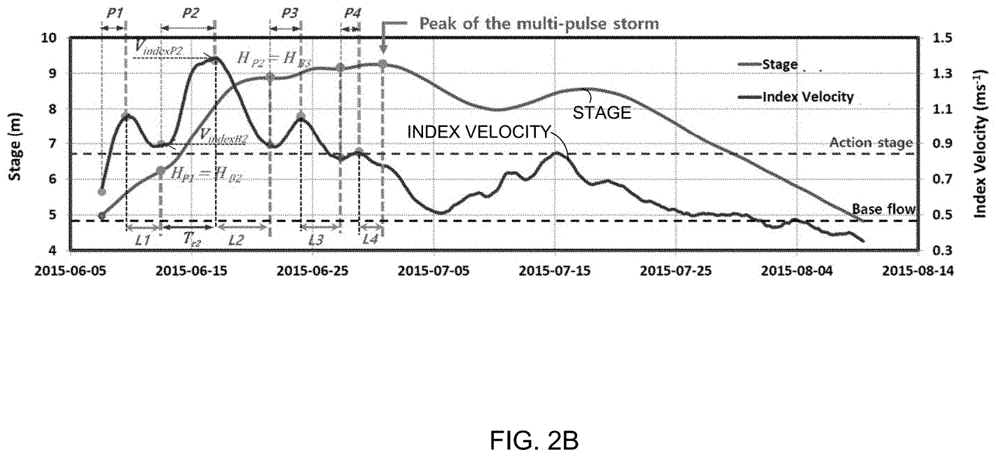

The basic assumption for developing the protocol is that passages of storm events at a hysteresis-prone site produce relationships between flow variables that replicate themselves for identical flow events passing through the site. In other words, unsteady flow pulses of the same intensity applied to the same state of the variables produce hysteretic loops with similar characteristics, whether the event is single- or multi-pulse storm. The flow acceleration, occurring on the ascending part of the pulse, is decisive for determining the severity of the hysteretic loops [51],[52]. For the protocol's conceptualization, we relied on the following terms (see also FIG. 2): pulse peaks, P, are consecutive data points leading to a peak in index velocity, V_{index}; time duration, Tᵣ, is the time for the pulse to reach its peak; the lag, L, is the time duration between the index velocity peak and the associated stage peak for each individual pulse; and indices B and P stand for the base and peak-of individual pulses. Identification of the above parameters can be automated using data-driven approaches (e.g., machine learning or similar).

We illustrate the proof-of-concept of the new data-driven forecasting concept with data acquired at the index-velocity gaging station USGS #05558300. We selected this site because the stream at this location is prone to hysteresis and because the data acquisition and processing are made with rigorous and uniform protocols over extended periods of time, therefore providing a reliable benchmark dataset. The station is equipped with a HADCP (i.e., 1500 kHz SonTek-SL), used in conjunction with typical index-velocity protocols. The HADCP measures continuously and unassisted stage and velocities with probes collocated in the same unit. This USGS gaging station drains an area of 35,080 km² through a cross section of about 10 m deep and 300 m wide at high flows. The maximum flow recorded at this station is 4,560 m³ s⁻¹ (Apr. 22, 2013) and the minimum flow is 30 m³ s⁻¹ (Mar. 3, 2015). The annual mean discharge for 2019 water year was 1,100 m³ s⁻¹ with a min-max range from 85 m³ s⁻¹ to 3,000 m³ s⁻¹ (with corresponding stages of 5.74 m, 4.5 m, and 9.5 m, respectively). During the same interval, the peak index velocity varied between 0.64 m s⁻¹ to 2.13 m s⁻¹. During the 2013-2019 interval, there were a total of 79 storm events propagating through this station. The training of the data-driven model was made by applying the algorithm to 65 single- and multiple-pulse storms recorded during the 2013-2018 interval and during the largest flood event recorded in 2019. We validated the algorithm against 4 storm events recorded during 2019 at the same station. We also used the developed algorithm for hindcasting the largest storms in each year during the analysis period. During the proof-of-concept phase of the development of the data-driven forecasting approach, we used only simple analysis tools and (quite extensive) manual data manipulations, as the intent of the initial investigation was to explore and conceptualize the algorithm's protocol and test its feasibility.

### Forecasting Protocol Formulation

The first step in formulating the protocol entailed the analysis of the records available at the station for identifying the hysteretic-related patterns and quantifying the relationships between the index-velocity peaks and their response in stage variation for each pulse occurring during storm events. Identification of the hysteretic patterns for single-pulse storm events is quite straightforward, as illustrated in FIG. 2A. A pulse in the index-velocity record is associated with a delayed peak in the stage hydrographs. For multi-pulse hydrographs (produced by successive storms separated by short time intervals, or inflows from tributaries entering the main-stream reach), the pairing of the index-velocity peaks with their response in the stage hydrographs requires more caution. FIG. 2B illustrates the incremental change of the variables produced by the propagation of a multi-pulse storm event up to the flood crest. For illustration of the used terminology, complete notations for the pairing of the second pulse peak, P2, are shown in FIG. 2B. Given that for flood crest prediction the timing and magnitude of the absolute maximum of the stage peak are of primary interest, our analysis entails only pulses located on the rising limb of the multi-pulse storms leading to the flood crest.

Quantification of the protocol relationships is a direct reflection of the interplay among the various terms in Equation (1) that, in turn, depend on the type of waves propagating through the site and the associated hysteresis intensity (i.e., ratio between pulse magnitude and the time taken to reach this specific magnitude). We account for hysteresis intensity by adopting the widely used unsteadiness coefficient [27]. Under the assumption of hydrostatic distribution, this coefficient is proportional to the lag between the maximum shear stress (that is highly correlated with the maximum V_{index} peak) and the maximum depth (i.e., stage peak). Consequently, the unsteadiness coefficient is defined as the ratio between the rising speed of the water surface, Vₛ, with respect to celerity, U_{c}. We deem that the unsteadiness coefficient describes the hysteresis intensity (a.k.a. severity) well, and that in turn determines the thickness of the hysteresis loop and the time lag between the index-velocity and the stage peaks associated for a specific pulse. Furthermore, as the rising limb is the most active period of the flood wave propagation [52], the severity is defined only for the duration of the rising limb, Tᵣ. Using notations illustrated in FIG. 2A, the unsteadiness coefficient a for single pulse can be defined as:

$$α = \frac{{V}_{s}}{{U}_{c}} = \frac{Δ {H}_{P}}{{T}_{r} {U}_{c}} = \frac{{H}_{P} - {H}_{B}}{{T}_{r}} \times \frac{2}{{V}_{indexB} + {V}_{indexP}} \qquad ( 3 )$$

For a multi-pulse storm, the unsteadiness coefficient is determined with measurements taken at the beginning of each individual pulse. In order to account for the state of the variables at the starting of the pulse, a non-dimensional term, H*, is introduced. Using notations illustrated in FIG. 2B, the severity of the individual pulses in a multi-pulse series is estimated by the normalized unsteadiness coefficient, a*:

$${α}^{*} = α \times {H}^{*} = \frac{{V}_{s}}{{U}_{c}} \times \frac{Δ {H}_{Pi}}{{H}_{B}} = \frac{Δ {H}_{Pi}}{{T}_{ri} {U}_{ci}} \times \frac{Δ {H}_{Pi}}{{H}_{B}} = \frac{{H}_{Pi} - {H}_{Bi}}{{T}_{ri}} \times \frac{2}{{V}_{indexBi} + {V}_{indexPi}} \times \frac{Δ {H}_{Pi}}{{H}_{B}} \qquad ( 4 )$$

where indices B and P stand for base and peak of the stage and index velocity for individual pulses, i, and H_{B} is the stage corresponding to the base flow for the specific measurement location. Equation (4) for multi-pulse storm events reduces to Equation (3) for a single-pulse storm, therefore from this point on our algorithm uses only the normalized unsteadiness coefficient, a*, for protocol description.

Given that some of the operational gaging stations prescribe warning levels for the flood severity at a specific location, we deemded that it is useful to include these parameters in the forecasting protocol, in addition to the above-described parameters characterizing the pulse intensity. By doing so, we distinguish between harmless index-velocity pulses from flooding perspectives (even if the pulses are intense) and those that require immediate attention as they predict potential for out-of-the-bank flows. FIG. 2 displays the Action Stage, i.e., the first level of warning established to inform U.S. communities of flood threats. If such a warning line does not exist for a measurement location, the forecasting protocol is only based on the unsteadiness coefficient defined by Equation (4).

In the second step of the protocol development, we assembled the unsteadiness coefficients for all the pulses in the training dataset used for developing the data-driven model, along with the variables that are associated with the coefficients' determination. FIG. 4A plots the normalized unsteadiness coefficients for our test gaging station, grouped in two clusters. The ∝₁*cluster contains coefficients associated with pulses that originate at stage values below the Action Stage at the origination of the pulse. The ∝₂*cluster contains parameters that are above the action stage. For our test site, only 14 storms in the 2013-2019 period have the peak stage above this stage. For sites that do not have established warning levels, the plot in FIG. 4A entails only one group of points corresponding to all the occurred storms.

In the third step of the protocol development, we used the aforementioned measured variables and the parameters derived from them for all the pulses in the training dataset to construct the following relationships (see FIGS. 4A-4C): i) peak index velocity vs. associated phase lag of the stage peak (see FIG. 4B); and ii) the magnitude of the index-velocity gradients and the associated stage peak gradient (see FIG. 4C). The generic form of the last two forecasting relationships is substantiated by applying exponential regression lines through the data cloud for each of the above-mentioned relationships. For our case study, where warning severity levels are available, these regression equations are clustered around the two groups of unsteadiness coefficients illustrated in FIG. 4A. The R² correlation coefficient for the regression lines in FIG. 4B are 0.91 and 0.65 for ∝* values above and below the Action Stage, respectively. The R² correlation coefficients for the regression lines in FIG. 4C are 0.75 and 0.61 for ∝* values above and below the Action Stage, respectively. If the warning levels do not exist for a specific gaging site, the forecasting relationships plotted in FIGS. 4B and 4C contain only one relationship. Needless to say, correlation coefficients improve with increased number of data points available in the training datasets.

In summary, the construction of the forecasting protocol entails the tracing, recording, and determining the following parameters for each individual pulse occurred during the storm: a) magnitude of the stage and index-velocity values at the onset of the index-velocity pulse; b) rates of change for the index velocity and stage associated with the pulse; c) duration of the rising of the pulse to its peak; d) unsteadiness coefficient; and e) the time interval between the index-velocity peak and the associated stage peak. This simple and intuitive tracing procedure is applied uniformly to the whole training dataset. Table 3 summarizes the essential data of the protocol formulation applied to the Henry gaging station.

TABLE 3
Summary of essential data used for protocol testing and validation

| | Derived | | Training dataset & | Testing dataset & |
|---|---|---|---|---|
| Inputs | quantities | Outputs | Period⁵ | Period⁵ |
| Stage TS¹ | α (Eq. 3) | Tᵣ—crest time lag | 65 storms/2014- | 5 storms/2014- |
| Bulk | α* (Eq. 4)³ | (FIG. 2) | 2018 & 1 storm | 2019 & largest |
| flow | ΔVₚ; ΔHₚ FIG. 2 | H_{P}—crest stage | (2019) | storms in (2019) |
| velocity | & 3b⁴ | (FIG. 2) | | |
| TS² | | | | |

TS—¹time series;
²index-velocity suffices;
³if flood warning levels are defined for the site;
⁴applied to single- and multiple-pulse storm events;
⁵statistical estimates of the goodness of fit (R²) for the prediction protocols are provided in Forecasting protocol formulation in Methods section.

The regression lines in FIG. 4B indicate that the larger pulse magnitudes (Peak Index Velocity) are paired with larger lags between the peaks of the index-velocity and stage hydrographs. It is noteworthy that the numerical values of the lags, L, range between 19 and 85 hours (equivalent to about 1 to 3.5 days), time intervals that are deemed appropriate for delivering short-term forecasts with the present approach. Similarly, FIG. 4C indicates that the larger storm pulse gradients (A Index Velocity) are paired with larger increases in stage peak magnitudes. The relative positions of the two groups of forecasting relationships (shown by the dotted lines in FIG. 4B and FIG. 4C seem to suggest that the larger flow stage, the slower the increase in lag between the index-velocity and stage peaks, and the faster the increase in their gradient relationship, respectively. For more definitive conclusions on the trends noticed in FIGS. 4B and 4C, there is a need for further evaluations on the data-driven modeling applied to considerably larger datasets and using companion numerical simulations

### Forecasting Protocol Implementation

If the regression equations illustrated in FIG. 4B and FIG. 4C are readily available for a specific measurement location, then the high-temporal resolution data for index-velocities should be closely observed for preparing the flood crest characteristics short-term forecasting. For stations where severity warning levels exists, only index velocity associated with higher than the Action Stage levels should be diligently monitored. Once an index-velocity peak is detected (ideally by a dedicated software module that also applies the needed data smoothening), the values of the peak index velocity, V_{indexpi}, and its timing are recorded. Back-tracing of the values of the index velocity, stage, the origin of the pulse (V_{indexpi}, and H_{Bi} respectively), and determining the rising time, Tᵣ, are subsequently made to allow for the estimation of the gradient in the index velocity, ΔVₘₐₓ Automation of the back-tracing and generalization of the algorithm would benefit from developing suitable data mining and specialized artificial intelligence tools.

The values determined above are then used in conjunction with the regression lines provided in FIGS. 4B and 4C to forecast the lag between the index-velocity peak and stage peak, as well as the corresponding gradient in the stage. The determined stage gradient is subsequently added to the stage at the origin of the pulse, H_{Bi}, to determine the magnitude of the forecasted crest, Hₚᵢ. This procedure is applied uniformly for single- and multiple-pulse storm events. During a multi-pulse storm, if a subsequent peak in index-velocity time series is observed while the stage continues to increase, the warning associated with the previous flagged pulse is canceled immediately and a new one is formulated using the same protocol. Indicated with straight-dotted lines in FIGS. 4B and 4C are the forecasted and actual parameters for Pulse #50, the largest storm recorded at this station in 2017. The selection of this pulse was made because it is located in the denser area of the training set, where it is deemed that the regression lines are less uncertain. Table 4 assembles samples of forecasted and actual recorded values for the flood crest magnitude and index velocity vs. stage peak lag for the largest storms of the water years 2014-2019 and for all the storms of 2019 water year that are above the Action Stage. The forecasted storm pulses cover storm severity levels 1 and 2 (i.e., ∝₁* and ∝₂*) as well as pulses pertaining to single- and multiple-storm events (i.e., Pulses #77 and #79 are the second and third pulses of a multi-pulse storm event).

TABLE 4
Comparison between actual measurements and hindcasted values for selected storm
pulses during the observation period at the USGS station #05558300.

| | Severity | | | Forecast | | | |
|---|---|---|---|---|---|---|---|
| Year - | (∝_{1,2}*)² & | Measurements | | | Lag | Difference (%)⁴ | |
| Pulse #¹ | Event type³ | Stage (m) | Lag (h) | Stage (m) | (h) | Stage | Lag |
| 2014 - #5 | (∝₁*) - | 5.0 | 34.3 | 5.3 | 33.3 | 5.7 | −3.0 |
| | single | | | | | | |
| 2015 - #27 | (∝₁*) - | 6.1 | 45.0 | 5.9 | 41 | -3.4 | −9.8 |
| | single | | | | | | |
| 2016 - #41 | (∝₁*) - | 6.1 | 29.3 | 6.2 | 27 | 1.6 | −7.4 |
| | single | | | | | | |
| 2017 - #50 | (∝₂*) - | 8.2 | 38.3 | 7.8 | 39 | -5.1 | 2.6 |
| | single | | | | | | |
| 2018 - #63 | (∝₂*) - | 6.8 | 41.8 | 6.9 | 39 | 1.4 | −7.7 |
| | single | | | | | | |
| 2019 - #67 | (∝₂*) - | 7.5 | 32.0 | 7.3 | 30.3 | -2.6 | −5.3 |
| | single | | | | | | |
| 2019 - #73 | (∝₂*) - | 9.5 | 65.0 | 9.8 | 64.7 | 3.1 | −0.3 |
| | single | | | | | | |
| 2019 - #77 | (∝₂*) - | 7.5 | 37.3 | 7.4 | 40.7 | -1.3 | 9.1 |
| | multi | | | | | | |
| 2019 - #79 | (∝₂*) - | 7.3 | 35.3 | 7.1 | 32.8 | -2.7 | −7.1 |
| | multi | | | | | | |

¹Pulse number lised in chronological order for the entire observsation period
²∝_{1,2}* as defined by Equation (4) for storms below or above Action Stage
³single-, multiple-pulse designated the type of event
⁴the reference values are the measured values of the stages and time of crest arrivals

Although various methods and systems have been shown and described herein, it is to be understood that the present invention contemplates numerous options, variations, and alternatives.

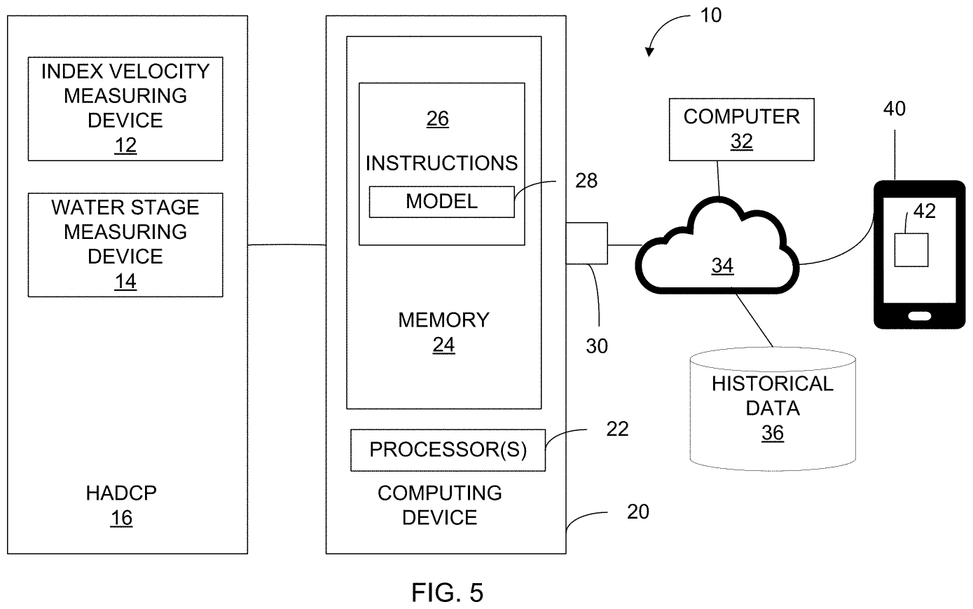

FIG. 5 illustrates one example of a system for streamflow casting. A system 10 includes an index velocity measuring device 12 and a water stage measuring device 14. The index velocity measuring device 12 and the water stage measuring device 14 may provide for simultaneously measuring index velocity and water stage. In some embodiments, the index velocity measuring device 12 and the water stage measuring device 14 may be integrated or implemented into a single system such as a HADCP (Horizontal Acoustic Doppler Current Profiler) 16. However, separate devices may be used. A computing device 20 is shown which is in operative communication with the HADCP 16 or the measuring devices 12, 14, individually. The computing device 20 may include one or more processors 22 and a machine readable non-transitory memory accessible by the one or more processors 22. The memory 24 may include a series of instructions 26 for implementing a data-driven model. In addition, the instructions 26 may provide for acquiring data from the HADCP 16 or measuring devices 12, 14, regression equations derived from the historical data, or otherwise. The instructions 26 applied to the incoming index-velocity and stage data may also provide for generating an alert or messages containing results of application of the data-driven model such as flood crest magnitude and/or arrival time. The computing device 20 may also include a network interface 30 which is operatively connected to the one or more processors 22. The network interface 30 allows the computing device to communicate over a network 34. Communications over the network 34 may be to acquire data such as historical data 36 for an index-velocity station. Alternatively, the historical data may be stored locally by the computing device 20. Communications over the network 34 may also be used to communicate results from the data-driven model such as to share an alert 42 to other computing devices 40 such as mobile devices or other types of devices. Note because the model is data-driven, forecasting may be performed quickly and accurately to generate alerts.

Although one example of a system is shown in FIG. 5 it is to be understood that numerous variations are contemplated. For example, the measuring devices may be remote from the computing device, historical data may be collected at the computing device, and the system need not provide for generating alerts.

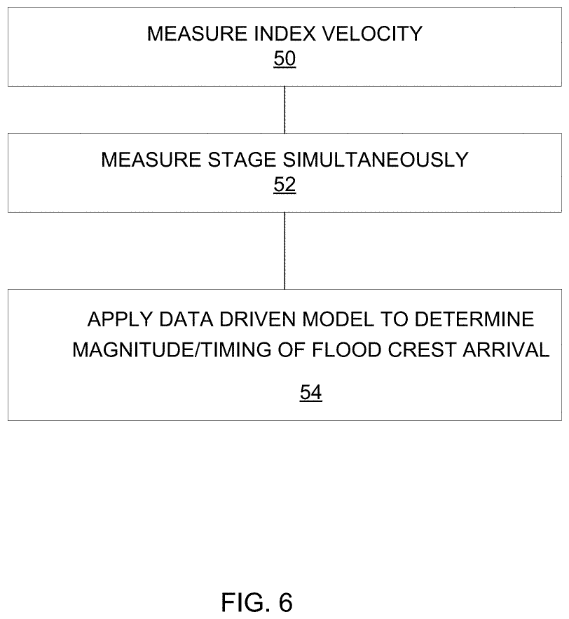

FIG. 6 illustrates one example of a method. In step 50, index velocity is measured. In step 52, a water stage measurement is made simultaneously with the measurement of the index velocity. In step 54, a data driven model is applied to determine the magnitude and/or timing of the flood crest arrival. It is further contemplated that one skilled in the art will appreciate that the model may be expanded to account for additional variables or factors as may be appropriate at a particular location. The most useful variable for this purpose is the measurement of free-surface slope in the stream that is closely related to the energy line driving the flow. As can be seen from FIGS. 1D and 1J, the free-surface slope is the first variable that peaks during the flood wave propagation, hence it enables even more lead time for forecasting the flood crest in comparison with the index-velocity approach. In addition, it is to be understood that additional steps may be performed once results are obtained. For example, an alert may be generated which may be communicated and may contain the magnitude and/or timing of the flood crest arrival. Additional steps may also be performed prior to these measurements such as to construct the data-driven model based on historic data. In addition, it is contemplated that measurements obtained may be used as additional historical data to improve future forecasting.

Although specific embodiments are shown and described, the present invention contemplates various options and alternatives. The methods described herein or aspects thereof may be incorporated into software in the form of instructions stored on a non-transitory computer or machine readable medium.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments may be described herein as implementing mathematical methodologies including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Where the term “processor” is used, it is to be understood that it encompasses one or more processors whether located together or remote from one other.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location. In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment or example.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function or “step for [perform]ing [a function] . . . ”, it is intended that such elements are to be interpreted under 35 U.S.C. 112§ (f). However, for any claims containing elements designated in any other manner, it is intended that such elements are not to be interpreted under 35 U.S.C. § 112(f).

The invention is not to be limited to the particular embodiments described herein. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes or methods of the invention. It is understood that any other modifications, substitutions, and/or additions can be made, which are within the intended spirit and scope of the invention.

### REFERENCES

The following references are incorporated by reference in their entireties as if set forth herein.
[1]. Mallakpour, I. & Villarini, G. The changing nature of flooding across the central United States. Nature Climate Change 5, 250-254 (2015).
[2]. Dawdy, D. R. Prediction versus understanding (The 2006 Ven Te Chow Lecture). Journal of Hydrologic Engineering 12, 1-3 (2007).
[3]. Milly, P. C. D. et al. Stationarity is dead: Whither water management? Science 319, 573-574 (2008).
[4]. Muste, M. et al. Revisiting hysteresis of flow variables in monitoring unsteady streamflows. Journal of Hydraulic Research 58, 867-887 (2020).
[5]. Meselhe, E. et al. Continental scale heterogeneous channel flow routing strategy for operational forecasting models. Journal of the American Water Resources Association 57, 209-221 (2021).
[6]. Pappenberger, F. et al. Influence of uncertain boundary conditions and model structure on flood inundation predictions. Advances in Water Resources 29, 1430-1449 (2006).
[7]. Georgakakos, K. P., Seo, D. J., Gupta, H., Schaake, J. & Butts, M. B. Towards the characterization of streamflow simulation uncertainty through multimodel ensembles. Journal of Hydrology 298, 222-241 (2004).
[8]. Wagener, T. & Gupta, H. V. Model identification for hydrological forecasting under uncertainty. Stochastic Environmental Research and Risk Assessment 19, 378-387 (2005).
[9]. Wilby, R. L. Uncertainty in water resource model parameters used for climate change impact assessment. Hydrological Processes 19, 3201-3219 (2005).
[10]. Sabur, M. A. & Steffler, P. M. A conservative diffusion wave flood routing scheme for channel networks. Canadian Journal of Civil Engineering 23, 566-570 (1996).
[11]. Slater, L. J., Singer, M. B. & Kirchner, J. W. Hydrologic versus geomorphic drivers of trends in flood hazard. Geophysical Research Letters 42, 370-376 (2015).
[12]. Knight, D. W. River hydraulics—A view from midstream. Journal of Hydraulic Research 51, 2-18 (2013).
[13]. Ramsbottom, D. M. & Whitlow, C. D. Extension of rating curves at gauging stations: best practice guidance manual. Environment Agency 1-257 (2003).
[14]. Yen, B. C. & Tang, W. H. Reliability of Flood Warning. Stochastic processes in water resources engineering 333-347 (1997).
[15]. Rantz, S. E. Measurement and computation of streamflow: volume 1. Measurement of stage and discharge. Geological Survey Water Supply Paper. 2175 vol. 1 (1982).
[16]. Levesque, V. A. & Oberg, K. A. Computing discharge using the index velocity method. U.S. Geological Survey Techniques and Methods 3-A23 (2012).
[17]. Smiths, C. F., Cordova, J. T., Wiele, S. M. The continuous slope-area method for computing event hydrographs scientific investigations report 2010-5241. U.S. Geological Survey Scientific Investigations Report 2010-5241 (2010).
[18]. Muste, M., Bacotiu, C. & Thomas, D. Evaluation of the slope-area method for continuous streamflow monitoring. 38th IAHR World Congress—“Water: Connecting the World” 38, 121-130 (2019).
[19]. Muste, M. & Kim, D. Augmenting the operational capabilities of SonTek/YSI streamflow measurement probes Objectives #1 & #2: On the performance of index-velocity to deliver accurate streamflows and support flood warnings: Case studies featuring SonTek/YSI-SL capabilit. SonTek/YSI—IIHR Collaborative Research Report 1-34 (2020).
[20]. Cheng, Z. et al. Experimental evidence on the performance of rating curves for continuous discharge estimation in complex flow situations. Journal of Hydrology 568, 959-971 (2019).
[21]. Holmes, R. R. River rating complexity. River Flow—Proceedings of the International Conference on Fluvial Hydraulics, RIVER FLOW 2016 679-686 (2016) doi:10.1201/9781315644479-107.
[22]. Henderson, F. Martin. Open channel flow (Macmillan, 1966). [23]. Herschy, R. W. Streamflow measurement 536 (CRC Press, 2009).
[24]. Dottori, F., Martina, M. L. V. & Todini, E. A dynamic rating curve approach to indirect discharge measurement. Hydrology and Earth System Sciences 13, 847-863 (2009).
[25]. Fenton, J. D. & Keller, R. J. The calculation of streamflow from measurements of stage. CRC for catchment hydrology (2001).
[26]. Hunt, A. E. The Behaviour of turbulence in unsteady open channel. PhD Thesis, University of Canterbury, (University of Canterbury, New Zealand, 1997).
[27]. Nezu, I., Kadota, A. & Nakagawa, H. Turbulent structure in unsteady depth-varying open-channel flows. Journal of Hydraulic Engineering 123, 752-763 (1997).
[28]. Graf, W. H. & Song, T. Bed-shear stress in non-uniform and unsteady open-channel flows. Journal of Hydraulic Research 33, 699-704 (1995).
[29]. Haizhou, T. & Graf, W. H. Friction in unsteady open-channel flow over gravel beds. Journal of Hydraulic Research 31, 99-110 (1993).
[30]. Ferrick, M. G. Analysis of river wave types. Water Resources Research 21, 209-220 (1985).
[31]. Arico, C. & Tucciarelli, T. Discharge and peak flow estimation using pairs of simultaneous water level measurements. in River Flow Conference 2423-2430 (2008).
[32]. Di Baldassarre, G. & Montanari, A. Uncertainty in river discharge observations: A quantitative analysis. Hydrology and Earth System Sciences 13, 913-921 (2009).
[33]. Lee, K. Evaluation of methodologies for continuous discharge monitoring in unsteady open-channel flows. PhD Thesis, The University of Iowa, Iowa City, (The University of Iowa, Iowa City, Iowa., 2013).
[34]. Fread, D. L. Computation of stage-discharge relationships affected by unsteady flow. JAWRA Journal of the American Water Resources Association 11, 213-228 (1975).
[35]. Ponce, V. M. Engineering Hydrology: Principles and Practices. (Prentice Hall, 1994).
[36]. Crago, R. D. & Richards, S. M. Nonkinematic effects in storm hydrograph routing. Journal of Hydrologic Engineering 5, 323-326 (2000).
[37]. Moots, E. E. A study in flood waves. PhD Thesis, The University of Iowa, Iowa City, (The University of Iowa, Iowa City, Iowa., 1927).
[38]. Liu, C., Cao, W., Xu, L., Li, D. & Wang, X. Shear velocity in the unsteady open channel flows. in Proceedings of the 2013 IAHR World Congress vol. 1 (2013).
[39]. Graf, W. H. & Qu, Z. Flood hydrographs in open channels. Proceedings of the Institution of Civil Engineers—Water Management 157, 45-52 (2004).
[40]. USGS (2021). National Water Information System: Web Interface, USGS 0558300 Illinois River at Henry, Ill., https://waterdata.usgs.gov/nwis/uv?site_no=05558300
[41]. Mishra, S. K. & Seth, S. M. Use of hysteresis for defining the nature of flood wave propagation in natural channels. Hydrological Sciences Journal 41, 153-170 (1996).
[42]. Friedman, J. H. A variable span scatterplot smoother. Laboratory for computational statistics http://www.dtic.mil/docs/citations/ADA148241 (1984).
[43]. NOAA. https://water.weather.gov/ahps/. National Weather Service.
[44]. Roy, T. et al. Detailed overview of the multimodel multiproduct streamflow forecasting platform. Journal of Applied Water Engineering and Research 8, 277-289 (2020).
[45]. Rahman Khan, M. et al. Uncertainty in remote sensing of streams using noncontact radars. Journal of Hydrology 603, 126809 (2021).
[46]. Xiang, Z. & Demir, I. Distributed long-term hourly streamflow predictions using deep learning—A case study for State of Iowa. Environmental Modelling and Software 131, 104761 (2020).
[47]. Sofia, G. & Nikolopoulos, E. I. Floods and rivers: a circular causality perspective. Scientific Reports 10, 1-17 (2020).
[48]. Mansanarez, V., Westerberg, I. K., Lam, N. & Lyon, S. W. Rapid stage-discharge rating curve assessment using hydraulic modeling in an uncertainty framework. Water Resources Research 55, 9765-9787 (2019).
[49]. Ouyang, R., Ren, L., Cheng, W. & Zhou, C. Similarity search and pattern discovery in hydrological time series data mining. Hydrological Processes 24, 1198-1210 (2010).
[50]. Gauch, M., Mai, J. & Lin, J. The proper care and feeding of CAMELS: How limited training data affects streamflow prediction. Environmental Modelling and Software 135, 104926 (2021).
[51]. De Sutter, R., Verhoeven, R. & Krein, A. Simulation of sediment transport during flood events: laboratory work and field experiments. Hydrological Sciences Journal 46, 599-610 (2001).
[52]. Mrokowska, M. M. & Rowinski, P. M. Impact of unsteady flow events on bedload transport: A review of laboratory experiments. Water 11, (2019).

What is claimed is:

1. A data-driven method for flood crest characteristics forecasting, the method comprising:
measuring index velocity at an index velocity gaging station to provide index velocity data;
simultaneously with measuring the index velocity, measuring water stage at the index velocity gaging station to provide stage data; and
applying a data-driven model implemented using a computing device to the index velocity data and the stage data, the data-driven model further using historical index velocity data and historical stage data collected at the index velocity gaging station to provide a forecast of at least one of a magnitude of a flood crest arrival during occurrence of a hydrological event and a timing of the flood crest arrival during the occurrence of the hydrological event.

2. The data-driven method of claim 1 wherein the index velocity data and the stage data are concurrently collected using a Horizontal Acoustic Doppler Current Profiler (HADCP).

3. The data-driven method of claim 2 wherein the applying the data-driven model uses magnitude of the stage data and the index velocity data at onset of an index velocity pulse, rates of change for the index velocity and stage associated with the index velocity pulse, duration of rising of the index velocity pulse to an index velocity peak, an unsteadiness coefficient, and a time interval between the index velocity peak and an associated stage peak.

4. The data-driven method of claim 1 further comprising generating using the computing device to generate an alert in advance of flood crest based on the forecast of at least one of the magnitude of the flood crest arrival and the timing of the flood crest arrival.

5. The data-driven method of claim 1 wherein the forecast includes both the magnitude of the flood crest arrival and the timing of the flood crest arrival.

6. The data-driven method of claim 1 further comprising acquiring the historical index velocity data and the historical stage data to use in the data-driven model.

7. The data-driven method of claim 1 wherein the hydrological event is a single pulse storm.

8. The data-driven method of claim 1 wherein the hydrological event is a multi-pulse storm.

9. The data-driven method of claim 1 further comprising calibrating a predictive channel routing numerical model using the forecast.

10. The data-driven method of claim 1 further comprising validating a predictive channel routing numerical model using the forecast.

11. The data-driven method of claim 1 wherein the data-driven model is implemented using a set of instructions and regression lines determined from historical data stored in a machine readable non-transitory medium of the computing device and executed by at least one processor of the computing device.

12. A system for implementing a data-driven method for streamflow forecasting, the system comprising:
a memory;
a processor operatively connected to the memory; and
a set of instructions stored on the memory for execution by the processor wherein the set of instructions are configured to apply a data-driven model to index velocity data and stage data, the data-driven model further using historical index velocity data and historical stage data to forecast at least one of a magnitude of a flood crest arrival and a timing of a flood crest arrival during occurrence of a hydrological event.

13. The system of claim 12 further comprising an index velocity measuring device for measuring the index velocity data and a water stage measuring device for measuring the stage data concurrently with the measuring of the index velocity data.

14. The system of claim 12 further comprising a Horizontal Acoustic Doppler Current Profiler configured to provide for measuring index velocity and measuring water stage.

15. The system of claim 14 further comprising a network interface operatively connected to the processor and wherein the set of instructions are further configured to generate an alert in advanced of the flood crest arrival based on at least one of the magnitude of the flood crest arrival and the timing of the flood crest arrival and to communicate the alert through the network interface to a network.

16. A data-driven method for flood crest characteristics forecasting, the method comprising:
measuring index velocity at an index velocity gaging station of a river or stream to provide index velocity data for flowing water;
simultaneously with measuring the index velocity, measuring water stage at the index velocity gaging station to provide stage data; and
applying a data-driven model implemented using a computing device to the index velocity data and the stage data, the data-driven model further using historical index velocity data and historical stage data collected at the index velocity gaging station to generate a forecast for at least one of magnitude of a flood crest arrival and timing of the flood crest arrival during occurrence of a hydrological event;
wherein the applying the data-driven model uses magnitude of the water stage and index velocity data at onset of an index velocity pulse, rates of change for the index velocity and the water stage associated with the index velocity pulse, duration of rising of the index velocity pulse to a peak, an unsteadiness coefficient, and a time interval between the peak and an associated stage peak.

17. The data-driven method of claim 16 wherein the index velocity data and the stage data are concurrently collected using a Horizontal Acoustic Doppler Current Profiler (HADCP).

18. The data-driven method of claim 17 wherein the index velocity data and the stage data are electronically communicated over a network to the computing device.

19. The data-driven method of claim 18 further comprising generating using the computing device to generate an alert in advance of flood crest based on at least one of the magnitude and the timing of the flood crest arrival.

20. The data-driven method of claim 19 wherein the data-driven model provides the forecast for both the magnitude of the flood crest arrival and the timing of the flood crest arrival.
